(19) United States
(12) Patent Application Publication
(10) Pub. No.: US 2025/0307336 A1
(43) Pub. Date: Oct. 2, 2025

(54) METHOD AND DEVICE FOR ENSURING EXECUTION OF FUNCTION FOR AVOIDING ADVERTISEMENT BLOCK

(71) Applicant: Adshield, Inc., Seoul (KR)

(72) Inventors: Joowon RYOO, Jersey City, NJ (US); Sang Hyeon JEON, Seoul (KR)

(73) Assignee: Adshield, Inc., Seoul (KR)

(21) Appl. No.: 19/082,624

(22) Filed: Mar. 18, 2025

(30) Foreign Application Priority Data
Mar. 29, 2024 (KR) 10-2024-0043511

(51) Int. Cl. G06F 16/957; G06Q 30/0241; H04L 67/02

(52) U.S. Cl. CPC G06F 16/9577; G06Q 30/0277; H04L 67/02

(57) ABSTRACT

An operation method of a server to provide an advertisement includes receiving an HTTP request from a client, and transmitting, to the client, an HTTP response with a script added, the script including at least one instruction to be executed on the client, wherein the at least one instruction may be executed by the client to detect whether an ad-blocking function is executed on the client using different web filtering techniques, and in the case that the ad-blocking function is not detected, to determine whether advertising content included in the HTTP response is loaded.

### CROSS-REFERENCE TO RELATED PATENT APPLICATION

The present application claims priority under 35 U.S.C. § 119(a) to Korean patent application number 10-2024-0043511 filed on Mar. 29, 2024, in the Korean Intellectual Property Office, the entire disclosure of which is incorporated by reference herein.

### BACKGROUND OF THE INVENTION

### 1. Field

The present disclosure relates to a method and device for providing an advertisement, and more specifically, to a method for providing an advertisement by ensuring execution of an advertisement blocking (“ad-blocking”) avoidance function to avoid an advertisement blocking function and a device for performing an advertisement providing method.

### 2. Description of the Related Art

Online advertising is one of the most important sources of revenue for online content publishers. Further, online advertising is one of the means to promote information about various products and services.

An online advertisement may be output in the form of a banner, pop-up, embedded, in-line, full-page ad, or pop-up which appears when a user visits or leaves a page. The online advertisement may be presented as a link, audio content, or visual content including text, images, and other multimedia content.

An advertisement blocker (“ad blocker”) blocks online advertisements on websites, such as HyperText Markup Language (HTML) pages and other downloadable content. The ad blocker may be a service which operates through a software application, browser component, extension, add-on, script, virtual private network (VPN), domain name system (DNS), or the like.

This ad blocker deprives content publishers of advertising revenue and also interferes with the marketing, promotion and information delivery of products and services. Therefore, there is a need to counteract the effects of the ad blocker so that content containing an advertisement is displayed by a client.

### SUMMARY OF THE INVENTION

An object of the present disclosure to solve the above problems is to provide a method, device, and system for providing an advertisement to a client even when an ad blocker is executed by the client or an external server such as a virtual private network (VPN) and a domain name system (DNS).

Another object of the present disclosure to solve the above problem is to provide a method, device, and system for ensuring execution of a script for ad-blocking on the client even when the ad-blocking function is executed by the client or the external server such as the VPN or DNS.

An operation method of a server to provide an advertisement to achieve the above objects includes: receiving an HTTP request from a client; and transmitting, to the client, an HTTP response with a script added, the script including at least one instruction to be executed on the client, wherein the at least one instruction may be executed by the client to prevent loading of at least one resource of the HTTP response based on whether the at least one instruction included in the script is executed on the client.

Here, the at least one instruction may be executed to load cascading style sheets (CSS).

Here, the script may be an inline script.

Here, the at least one instruction of the script may be obfuscated.

Here, the at least one instruction of the script may be executed to determine whether the at least one instruction included in the script is executed and remove at least one resource included in the HTTP response in the case that the at least one instruction included in the script is not executed.

Here, in determining whether the at least one instruction included in the script is executed, the at least one instruction of the script may be executed to determine whether loading of the at least one instruction is blocked, and determine whether the at least instruction is modified.

Here, the at least one instruction of the script may be executed to, in the case that at least one resource included in the HTTP response is not removed, redirect to a preset separate page.

There is provided a non-transitory computer recording medium including at least one instruction executed by a processor to achieve the above objects, wherein the at least one instruction may be executed to: receive an HTTP request from a client; transmit, to the client, an HTTP response with a script added, the script including at least one instruction to be executed on the client, and at least one instruction of the script may be executed by the client to prevent loading of at least one resource of the HTTP response based on whether the at least one instruction included in the script is executed on the client.

Here, at least one instruction of the script may be executed to load cascading style sheets (CSS).

Here, the script may be an inline script.

Here, the at least one instruction of the script may be obfuscated.

Here, the at least one instruction of the script may be executed to determine whether the at least one instruction included in the script is executed, and remove at least one resource included in the HTTP response in the case that the at least one instruction included in the script is not executed.

Here, in determining whether the at least one instruction included in the script is executed, the at least one instruction of the script may be executed to determine whether loading of the at least one instruction is blocked, and determine whether the at least instruction is modified.

Here, the at least one instruction of the script may be executed to, in the case that at least one resource included in the HTTP response is not removed, redirect to a preset separate page.

An operation method of a client to provide an advertisement to achieve the above objects includes: transmit an HTTP request to a server; receiving an HTTP response with a script added, the script including at least one instruction; executing the at least one instruction of the script; and outputting the HTTP response based on a result of the execution of the at least one instruction of the script, wherein the at least one instruction may be executed by the client to prevent loading of at least one resource of the HTTP response based on whether the at least one instruction included in the script is executed on the client.

Here, the script may be an inline script including at least one instruction which is executed to load cascading style sheets (CSS).

Here, the at least one instruction of the script may be obfuscated.

Here, the executing of the at least one instruction of the script may include determining whether the at least one instruction included in the script is executed, and removing at least one resource included in the HTTP response in the case that the at least one instruction included in the script is not executed.

Here, the determining of whether the at least one instruction included in the script is executed may include determining whether loading of the at least one instruction is blocked, and determining whether the at least one instruction is modified.

Here, the operation method may further include, in the case that at least one resource included in the HTTP response is not removed, redirecting to a preset separate page.

According to an advertisement providing method of the present disclosure, even when the ad-blocking function is executed by the client or the external server such as the VPN or DNS, it is possible to ensure execution of a script for avoiding the ad-blocking function on the client.

### BRIEF DESCRIPTION OF THE DRAWINGS

FIG. 1 is a diagram illustrating an embodiment of a structure of an advertisement providing system.

FIG. 2 is an exemplary diagram illustrating a hardware configuration of a device included in the advertisement providing system according to FIG. 1.

FIG. 3 is a schematic diagram illustrating signal flows between respective components in an advertisement providing system.

FIG. 4 is a flowchart illustrating operations of respective components in an advertisement providing system.

FIG. 5 is a flowchart illustrating an ad-blocking avoidance operation of a client executing an ad-blocking avoidance script of an advertisement providing system.

FIG. 6 is a flowchart illustrating an operation of a client which ensures execution of an ad-blocking avoidance script.

FIG. 7 is a flowchart illustrating an operation of a client of determining whether at least one instruction included in an ad-blocking avoidance script is executed.

FIG. 8 is a flowchart illustrating an operation of a client of determining whether at least one instruction included in an ad-blocking avoidance script is executed.

### DETAILED DESCRIPTION

The present disclosure may have various modifications and embodiments, and specific embodiments are illustrated in the drawings and described in detail. However, this is not intended to limit the present disclosure to specific embodiments, but should be understood to include all modifications, equivalents, or substitutes included in the spirit and technical scope of the present disclosure.

The terms such as first and second may be used to describe various components, but such components should not be limited by such terms. The above terms are used merely to distinguish one component from another. For example, without departing from the scope of the present disclosure, a first component may be named a second component, and similarly, the second component may also be named the first component. The term “and/or” includes any combination of a plurality of related described items or any one of the plurality of related described items.

When it is mentioned that a component is “coupled” or “connected” to another component, it should be understood that the component may be directly coupled or connected to the other component, but there may be another component between them. On the other hand, when it is mentioned that a component is “directly coupled” or “directly connected” to another component, it should be understood that there are no other components between them.

The terminology used in the present application is used only to describe particular embodiments and is not intended to limit the present disclosure. Singular expressions include plural expressions unless the context clearly indicates otherwise. In the present application, it should be understood that terms such as “comprise”, “include”, or “have” are intended to specify the presence of a feature, number, step, operation, component, part or combination thereof described in the specification, but do not exclude in advance the possibility of the presence or addition of one or more other features, numbers, steps, operations, components, parts or combinations thereof.

Unless otherwise defined, all terms used herein, including technical or scientific terms, have the same meaning as commonly understood by a person skilled in the art to which the present disclosure pertains. Terms defined in commonly used dictionaries should be interpreted as having meaning consistent with their meaning in the context of the relevant art, and will not be interpreted in an idealized or overly formal sense, unless expressly defined in the present application.

Hereinafter, with reference to the accompanying drawings, preferred embodiments of the present disclosure will be described in detail. In order to facilitate overall understanding when describing the present disclosure, the same reference numerals are used for the same components in the drawings, and redundant descriptions of the same components are omitted.

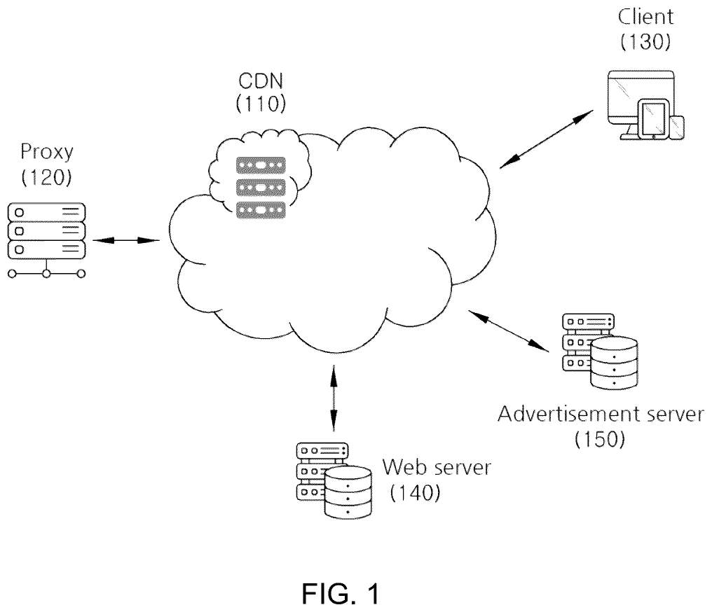

FIG. 1 is a diagram illustrating an embodiment of a structure of an advertisement providing system.

Referring to FIG. 1, the advertisement providing system may include a content delivery network (CDN) 110, one or more proxies 120, one or more clients 130, one or more web servers 140, and one or more advertisement servers 150. Each component of the advertisement providing system may be connected and communicate via the Internet.

The CDN 110 may be a network of distributed nodes and/or a data center connected to a network of nodes. The CDN 110 may utilize an Internet service provider, a carrier, or the like, to host nodes, servers, and data centers. A content provider may deliver content to the client 130 by utilizing the components of the system including the CDN 110.

The proxy 120 may be a network-accessible device which may operate independently of the CDN 110, the client 130, and the server. According to an embodiment, the proxy 120 may be linked to the web server 140 to perform network access operations. The proxy may be a forward proxy or a reverse proxy.

The client 130 may be a device having a processor which executes an application for processing, rendering, or displaying content. For example, the client 130 may be at least one of a laptop computer, a smartphone, a tablet, and a desktop computing machine. The most common application for processing, rendering, or displaying content is a web browsing application, but may include other applications as well.

The web server 140 may be a server for hosting and delivering content. The content may refer to any website, text, document, file, media, application, service, or game which is digitally encoded and can be transmitted over a network. The content may be displayed by the client 130 along with information about an advertisement provided by one or more advertisement servers 150.

The advertisement server 150 may be a server for hosting and delivering various advertisements embedded within content publisher content. While receiving and processing the content, in the case that the client 130 calls the advertisement, the advertisement server 150 may provide advertisement information which may be provided to the client 130. The advertisement may be configured within the content or rendered or displayed in a specified manner.

Configurations of the devices of the advertising serving system may be as described below.

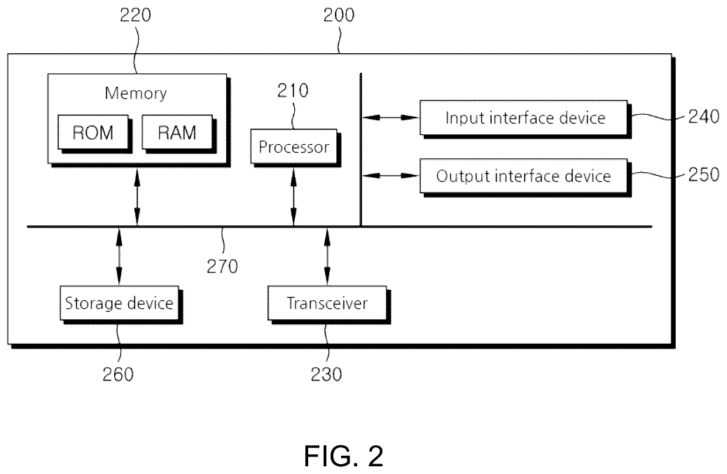

FIG. 2 is an exemplary diagram illustrating a hardware configuration of a device included in the advertisement providing system according to FIG. 1.

Referring to FIG. 2, a device 200 may include at least one processor 210 and a memory 220 which stores instructions instructing the at least one processor 210 to perform at least one step.

Here, at least one processor 210 may refer to a central processing unit (CPU), a graphics processing unit (GPU), or a dedicated processor on which methods according to embodiments of the present disclosure are performed. Each of the memory 220 and a storage device 260 may be composed of at least one of a volatile storage medium and a non-volatile storage medium. For example, the memory 220 may be composed of at least one of read only memory (ROM) and random access memory (RAM).

In addition, the device 200 may include a transceiver 230 which performs communication via a wireless network. Additionally, the device 200 may further include an input interface device 240, an output interface device 250, and the storage device 260. Each component included in the device 200 may be connected by a bus 270 to communicate with each other.

Flows of signals exchanged between the devices of the advertisement providing system may be as described below.

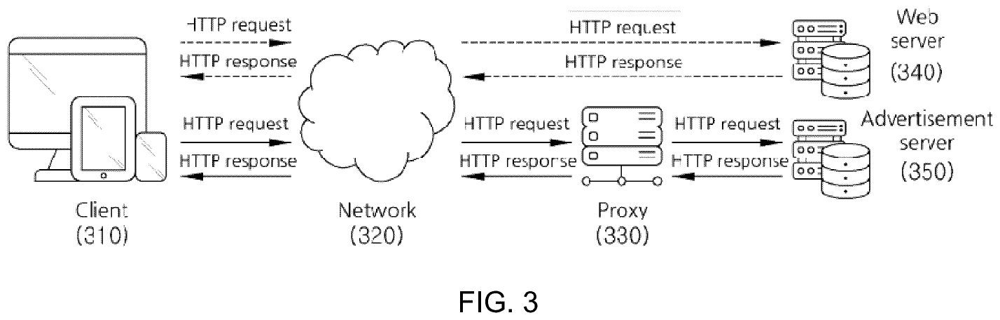

FIG. 3 is a schematic diagram illustrating signal flows between respective components in an advertisement providing system.

Referring to FIG. 3, the advertisement providing system may include a client 310, a network 320, a proxy 330, a web server 340, and an advertisement server 350. However, some components of the advertisement providing system may be omitted.

Referring to FIG. 3, the client 310 may request HTTP content from an external server such as the web server 340. Request for HTTP content may be made by calling a specific link or by starting any application which loads the content. An HTTP content request may typically be transmitted in the form of an HTTP GET request along with a URL identifying the address and content of an external server, such as the web server 340.

In an embodiment, the HTTP content request may be forwarded to the web server 340 over the network 320, as indicated by dotted lines. Alternatively, the HTTP content request may be forwarded to the web server 340 via the network 320 and proxy 330, as shown by solid lines.

In an embodiment, when an ad-blocking application is executed or an ad-blocking function is performed on the client, the HTTP content request may be forwarded along the solid line path. On the other hand, when no ad-blocking function is performed on the client, the HTTP content request may be forwarded along the dotted line path. In other words, when the ad-blocking function is not performed on the client, a script for avoiding ad-blocking according to the present disclosure may not be performed or may be performed only partially. When the ad-blocking function is not performed on the client, at least one instruction for avoiding the ad-blocking application in the script for avoiding ad-blocking according to the present disclosure may not be actively executed.

The web server 340 may insert a script for avoiding ad-blocking into an HTML script of a web page. The script for avoiding ad-blocking may include at least one instruction for avoiding the ad-blocking application executed on the client.

The web server 340 may transmit an HTTP response corresponding to the HTTP content request. Here, the HTTP response may include HTTP content and advertisement information for calling an advertisement. The advertisement information may include the address of the advertisement server 350 and HTML properties for specifying the advertisement. In addition, the HTTP response may further include a script for avoiding ad-blocking.

In an embodiment, the HTTP response may be forwarded to the client 310 over the network 320, as indicated by dotted lines. Alternatively, the HTTP response may be forwarded to the client 310 via the proxy 330 and the network 320, as shown by solid lines.

The client 310 requesting the HTTP content may receive the HTTP response including the HTTP content from the proxy 330 and/or the network 320. When the ad-blocking function is not executed by the client 310, the client 310 may request the advertisement from the advertisement server 350 based on the advertisement information included in the HTTP response.

When the ad-blocking function is not executed by the client 310, the client 310 may request the advertisement from the advertisement server 350 based on the advertisement information included in the HTTP response.

In response to an advertisement request message, the advertisement server 350 may transmit an advertisement response message. Here, the advertisement response message may include advertisement information for calling an advertisement. In an embodiment, the advertisement response message may be forwarded to the client 310 via the network 320, as indicated by the dotted lines.

The client 310 may receive the advertisement response message from the network 320 and render the advertisement information based on the advertisement information in the advertisement response message.

On the other hand, the ad-blocking function executed by the client 310 or an external server such as a virtual private network (VPN) or domain name system (DNS) may block the advertisement call based on the advertisement information included in the HTTP response.

Here, the client 310 may execute at least one instruction included in an ad-blocking avoidance script included in the HTTP response. As a result, the client 310 may perform at least one function and/or operation to avoid the ad-blocking function.

Alternatively, the client 310 may avoid execution of the ad-blocking function by executing the ad-blocking avoidance script included in the HTTP response. In the case that the ad-blocking function is avoided, the client 310 may transmit the advertisement request message to the advertisement server 350 to request advertisement information based on the advertisement information included in the HTTP response. In an embodiment, the advertisement request message may be forwarded to the advertisement server 350 via the network 320 and the proxy 330, as indicated by the solid lines.

The advertisement server 350 may transmit an advertisement response message corresponding to the advertisement request message. Here, the advertisement response message may include advertisement information for calling the advertisement. In an embodiment, the advertisement response message may be forwarded to the client 310 via the proxy 330 and the network 320.

The proxy 330 which receives an advertisement response message from the external server including the advertisement server 350 may modify at least a part of the advertisement response message received from the web server 340. For example, the proxy 330 may modify content, the advertisement information, or the like, included in the advertisement response message. In an embodiment, the proxy 330 may perform operations such as encrypting and/or obfuscating the content and/or advertisement information. The proxy 330 may add instructions such as scripts to the advertisement response message. The proxy 330 may transmit the modified advertisement response message to the client 310. The modified advertisement response message may be forwarded to the client 310 via the network 320, but may also be transmitted directly without via the network 320.

The client 310 may receive the modified advertisement response message and output the advertisement based on the received advertisement response message. Therefore, the client 310 may successfully call the advertisement.

Operations of the devices due to the flows of signals exchanged between the devices of the advertisement providing system may be as described below.

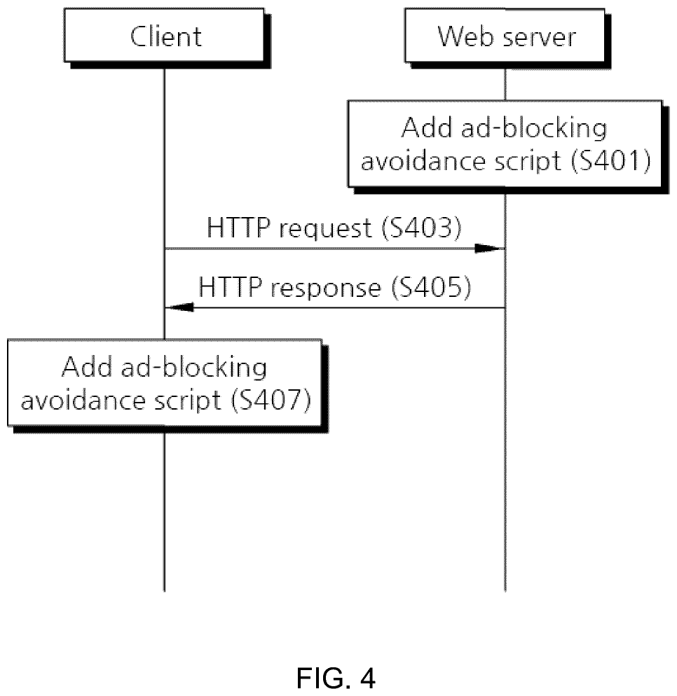

FIG. 4 is a flowchart illustrating operations of respective components in an advertisement providing system.

Referring to FIG. 4, the advertisement providing system may include a client, a network, a proxy, a web server, and an advertisement server. Some components of the advertisement providing system may be omitted.

At step S401, the web server may insert an ad-blocking avoidance script into an HTML script of the web page. Here, the ad-blocking avoidance script may include at least one instruction which is executed to perform at least one function and/or operation for avoiding the ad-blocking function.

At step S403, the client may transmit an HTTP request to the web server. Here, the HTTP request may be forwarded to the web server through the network and/or the proxy.

At step S405, the web server may transmit an HTTP response corresponding to the HTTP request. Here, the HTTP response may include an ad-blocking avoidance script. In addition, the HTTP response may include a recovery script to utilize at least some areas on the web page.

At step S407, the client may execute at least one script included in the HTTP response. The client may avoid the ad-blocking function by executing the ad-blocking avoidance script included in the HTTP response. Further, the client may output contents including advertisement contents provided through the web page.

Advertisement information provided by the web server may be script-based advertisement information. The script-based advertisement information may be rendered dynamically. As a result, when executing the script-based advertisement information, an advertisement layout, which is a layout for outputting an advertisement, may be dynamically generated.

A native advertisement refers to an advertisement which is planned and produced in a unique way to fit the website. The native advertisement operates as a part of content experienced by a website user, and uses a format which actively attracts the user's attention more than traditional advertising. Since, for the native advertisement, since “imageUrl”, “clickUrl”, and the like, are all separated, it is possible to obfuscate the advertisement information and render it directly based on this.

Unlike information of native properties, layout information about the script-based advertisement information is rendered dynamically, so an avoidance function of the ad-blocking function such as obfuscation may not be applied to the script-based advertisement information. Therefore, a method of avoiding the ad-blocking function applicable to dynamically rendered script-based advertisement information is required. The method of avoiding the ad-blocking function may be executed through at least one instruction included in an ad-blocking avoidance script included in an HTTP response.

Here, an ad-blocking avoidance operation of the client executing the ad-blocking avoidance script may be as described below.

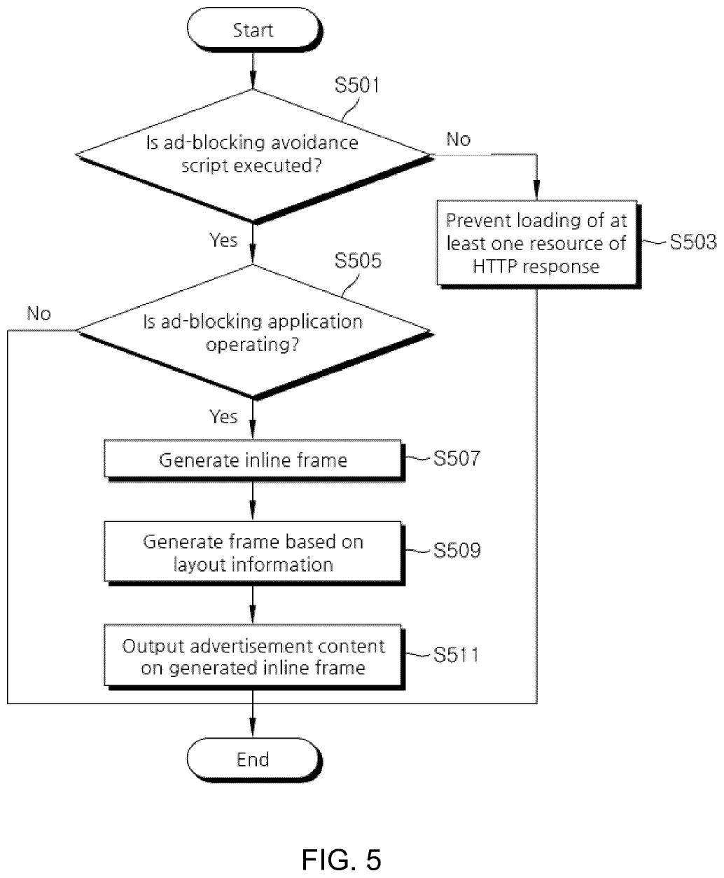

FIG. 5 is a flowchart illustrating an ad-blocking avoidance operation of a client executing an ad-blocking avoidance script of an advertisement providing system.

Referring to FIG. 5, the operation described in FIG. 5 may be executed by a client which performs an ad-blocking avoidance function. The client which performs the ad-blocking avoidance function is referred to as a client below.

At step S501, the client may determine whether an ad-blocking avoidance script is executed. Here, the ad-blocking avoidance script may include at least one instruction which is executed to output advertisement content by avoiding an ad-blocking application executed by the client. In an embodiment, the ad-blocking avoidance script may be executed to prevent loading of at least one resource of an HTTP response based on whether at least one instruction included in the ad-blocking avoidance script is executed.

In the case that the at least one instruction included in the ad-blocking avoidance script is not executed, at step S503, the client may prevent the loading of at least one resource of the HTTP response. Therefore, the client may terminate an operation related to the HTTP response.

On the other hand, in the case that at least one instruction included in the ad-blocking avoidance script is executed, at step S505, the client may detect the ad-blocking application and determine whether the ad-blocking application is operating. The client may perform an operation related to ad-blocking avoidance based on a result of detection of the ad-blocking application. In the case that no ad-blocking application is detected, the client may not be executing an ad-blocking application. Therefore, the client may terminate the operation related to ad-blocking avoidance.

On the other hand, in the case that the ad-blocking application is detected, at step S507, the client may generate an inline frame including a script which is executed to output advertisement content on a web page. The inline frame may include at least one script and instruction for outputting advertisement content.

According to an embodiment, the inline frame may be generated based on layout information of the advertisement content, which is information about an area on the web page where the advertisement content is output. The advertisement content layout information may be stored encrypted in the HTTP response. In this case, the client may decrypt and acquire the encrypted advertisement content layout information of the HTTP response. Alternatively, the advertisement content layout information may be acquired from an external server.

At step S509, the client may add the inline frame to the web page.

At step S511, the client may output the advertisement content on the generated inline frame. The client may execute scripts and instructions in the frame to output the advertisement content in an area indicated by layout information on the web page.

In other words, the client performing the ad-blocking avoidance function may determine whether the ad-blocking avoidance script is executed, and based on the determination result, execute it to prevent the loading of at least one resource of the HTTP response. In an embodiment, an instruction of an ad-blocking script may be an instruction which is executed to load CSS. Alternatively, the ad-blocking script is an inline script which is not blocked by the ad-blocking function, and the instruction of the script may be obfuscated. Further, the client may determine whether the ad-blocking avoidance script is executed based on whether the instruction included in the script is modified and whether loading is blocked.

In the case that the at least one instruction included in the ad-blocking avoidance script is not executed, the client may prevent the loading of at least one resource in the HTTP response. The client may prevent the loading of at least one resource included in the HTTP response by removing the resource. Alternatively, the client may prevent the loading of the resource by redirection to a preset separate page.

The client which executes at least one instruction of the ad-blocking avoidance script may perform additional operations to avoid ad-blocking. The client may detect the ad-blocking function and determine whether the ad-blocking function is being executed.

The client may detect the ad-blocking function by sequentially using web filtering techniques of different complexity. In an embodiment, the client may detect the ad-blocking function by primarily using a cosmetic detection technique. Additionally, the client may detect the ad-blocking function using a network filtering technique and/or a snippet detection technique. Nonetheless, in the case that the ad-blocking function is not detected, the client may load the advertisement content and detect the ad-blocking function by determining whether the advertisement content is loaded.

When detecting the ad-blocking function, the client may generate an inline frame which is executed to output the advertisement content. Here, the inline frame may be generated based on advertisement layout information. As a result of executing scripts of the inline frame, an API of a browser application may be overridden. Accordingly, a request message for calling a script of the inline frame and a response message for acquiring a result of the call may be exchanged through a proxy server. Here, at least some information of the response message for acquiring the result of the call for the script of the inline frame may be encrypted and/or obfuscated.

Therefore, the client may output the advertisement content by executing the script of the inline frame. Here, the advertisement content may be output based on the advertisement layout information. The ad-blocking avoidance function as described above may also be applied to dynamically rendered script-based advertisement information.

Here, the ad-blocking avoidance script may include an instruction which is executed to load an essential resource for loading content of the HTTP response. In an embodiment, the ad-blocking avoidance script may be executed to load resources, such as cascading style sheets (CSS) and javascript (JS), of a web page output by the HTTP response. Specifically, at least one instruction of the ad-blocking avoidance script included in the HTTP response may be inserted to replace the CSS which loads the existing resource.

In the case that the ad-blocking application executed on the client blocks the ad-blocking avoidance script, the operation of resource loading by the ad-blocking avoidance script is also be stopped.

In another embodiment, the ad-blocking avoidance script may be a form of script which is difficult to detect by the ad-blocking application. For example, the ad-blocking avoidance script may be an inline script. Further, the ad-blocking avoidance script may include at least one obfuscated instruction. For example, at least one instruction included in the ad-blocking script may be obfuscated using a JavaScript obfuscation method. By the inline script including the obfuscated instruction, the client may execute the ad-blocking avoidance script by avoiding execution of the ad-blocking application.

In the case that the ad-blocking avoidance script is not executed, operations of the client for blocking content output may be as described below.

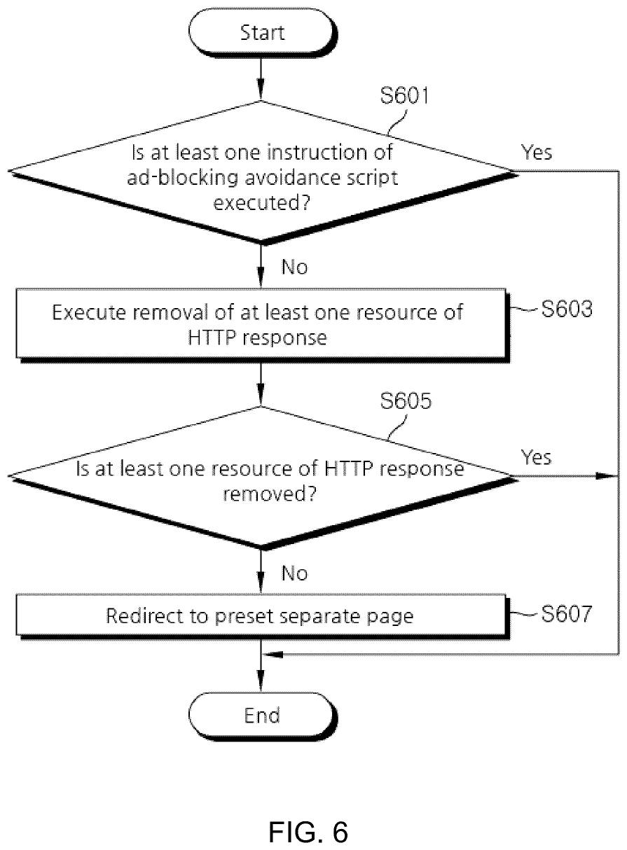

FIG. 6 is a flowchart illustrating an operation of a client which ensures execution of an ad-blocking avoidance script.

Referring to FIG. 6, the operation described in FIG. 6 may be executed by the client which performs an ad-blocking avoidance function. The client which performs the ad-blocking avoidance function is referred to as a client below.

At step S601, the client may determine whether at least one instruction included in the ad-blocking avoidance script is executed. In the case of determining that the at least one instruction included in the ad-blocking avoidance script is executed, the client may perform at least one operation for avoiding ad-blocking.

In the case that the at least one instruction included in the ad-blocking avoidance script is not executed, at step S603, the client may execute an operation to remove at least one resource included in an HTTP response.

In an embodiment, the client may retry the operation of step S601 multiple times. In the case that the at least one instruction included in the ad-blocking avoidance script is not executed despite multiple retries of step S601, the client may execute an operation to remove at least one resource included in the HTTP response.

At step S605, the client may determine whether at least one resource included in the HTTP response has been removed. The client may stop loading the HTTP response in the case of determining that at least one resource included in the HTTP response has been removed.

In the case of determining that at least one resource included in the HTTP response has not been removed, at step S607, the client may be redirected to a preset separate page. Here, the client may be implemented to be redirected to a preset separate page using an API which is not modified by the ad-blocking function. In an embodiment, the API which is not modified by the ad-blocking function may be a location.href property which specifies a particular URL to be called when an error occurs.

Therefore, in the case of determining that the ad-blocking avoidance script is not executed properly due to the ad-blocking function, the client may stop loading the HTTP response or be redirected to a separate page.

Here, an operation of the client of determining whether at least one instruction included in the ad-blocking avoidance script is executed may be as described below.

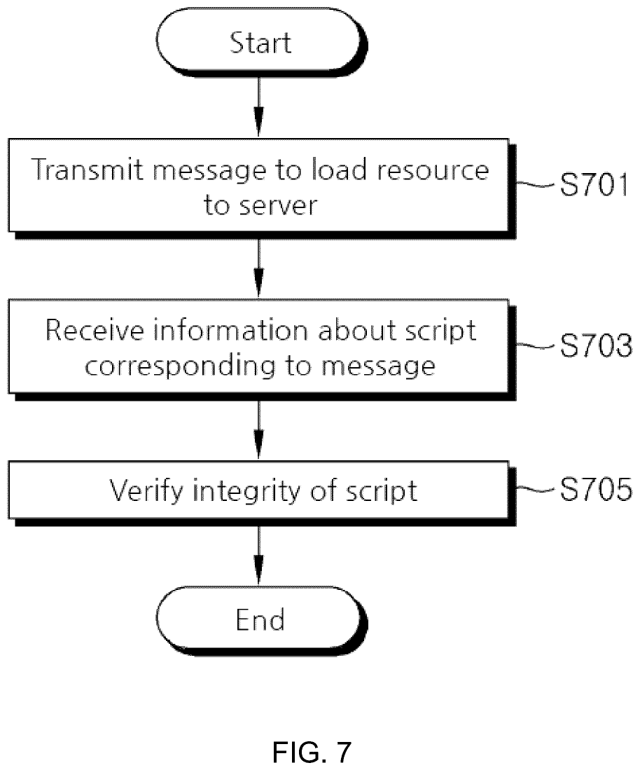

FIG. 7 is a flowchart illustrating an operation of a client of determining whether at least one instruction included in an ad-blocking avoidance script is executed.

Referring to FIG. 7, the operation described in FIG. 7 may be executed by the client which performs an ad-blocking avoidance function. The client which performs the ad-blocking avoidance function is referred to as a client below.

At step S701, the client may transmit a message to load a resource through at least one instruction included in the ad-blocking avoidance script to a server. A message for transmitting a resource may be referred to as a post message (postMessage). Here, the postMessage may have a specific key value or token value. The server which receives the postMessage may transmit information about a script corresponding to the postMessage to the client.

At step S703, the client may receive the information about the script corresponding to the postMessage from the server, and according to an embodiment, the client may receive the information about the script corresponding to the postMessage using an addEventListener method.

At step S705, the client may verify the integrity of the script corresponding to the postMessage based on the received information. In an embodiment, the client may determine whether the payload of the script corresponding to the postMessage is modified and whether a redirect is performed when the script is called. Further, the client may verify the integrity of the script based on whether the payload is modified and whether the redirect is performed when the script is called.

Additionally, the client may acquire a key value or token value included in the information about the script. The client may verify the integrity of the script based on whether the key value or token value of the postMessage matches the key value or token value included in the information acquired from the server.

In another embodiment, the ad-blocking avoidance script may include at least one instruction which is executed in the form of an event handler. For example, at least one instruction included in an ad-blocking script may ensure execution of the ad-blocking avoidance script by stopping loading of a resource included in an HTTP response in the case that an event occurring during the execution of the ad-blocking avoidance script is detected.

Here, an operation of the client of determining whether the at least one instruction included in the ad-blocking avoidance script is executed may be as described below.

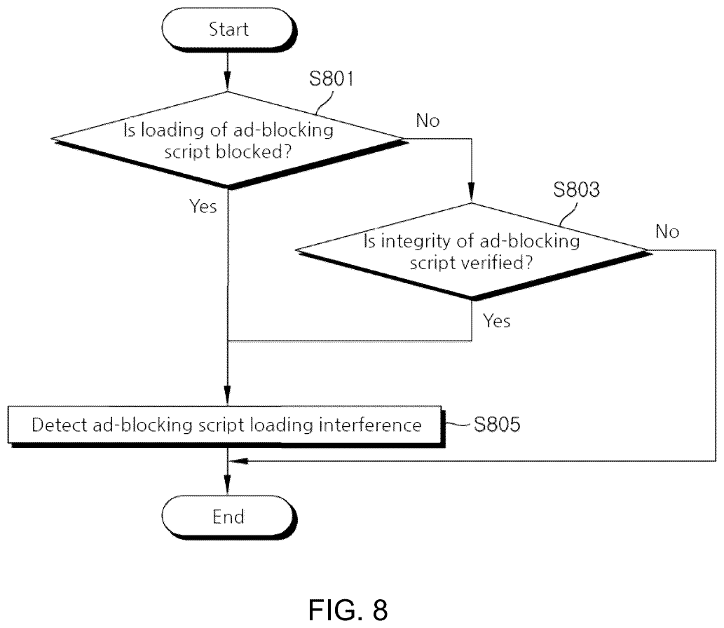

FIG. 8 is a flowchart illustrating an operation of a client of determining whether at least one instruction included in an ad-blocking avoidance script is executed.

Referring to FIG. 8, the operation described in FIG. 8 may be executed by the client which performs an ad-blocking avoidance function. The client which performs the ad-blocking avoidance function is referred to as a client below.

The client may ensure execution of the ad-blocking avoidance script by executing an instruction in the form of an event handler. Here, the instruction in the form of the event handler may be an instruction defined by an onload property which is executed to call code and an onerror property which is executed to call code when an error event occurs.

At step S801, the client may determine whether loading of at least one instruction included in an ad-blocking script is blocked.

In the case that the loading of at least one instruction included in the ad-blocking script is blocked, at step S805, the client may call the error event. The client may call code corresponding to the error event by executing an instruction of the onerror property of the event handler.

On the other hand, in the case that the loading of at least one instruction included in the ad-blocking script is not blocked, the client may verify the integrity of the script being loaded. The client may call code to verify the integrity by executing an instruction of the onload property of the event handler. The client may verify the integrity of the script being loaded based on whether keys or token values match for the postMessage and the script being loaded as described in FIG. 7 and related disclosure.

In the case that the integrity of the script is verified, the client may determine that at least one instruction included in the ad-blocking avoidance script is executed. On the other hand, in the case that the code corresponding to the error event is called or the integrity of the script is not verified, the client may determine that at least one instruction included in the ad-blocking avoidance script is not executed.

In the case of determining that the at least one instruction included in the ad-blocking avoidance script is not executed, the client may perform the operation described in FIG. 6 and related disclosure. Therefore, it is possible to ensure the execution of the ad-blocking avoidance script even when the ad-blocking function is executed.

The methods according to the present disclosure may be implemented in the form of program instructions which may be executed through various computer means and recorded on a non-transitory computer-readable medium. The non-transitory computer-readable medium may include program instructions, data files, data structures, and the like, alone or in combination. The program instructions recorded on the computer-readable medium may be those specially designed and configured for the present disclosure or may be known and available to those skilled in the art of computer software.

Examples of the non-transitory computer-readable medium include hardware devices specifically configured to store and execute program instructions, such as ROM, RAM, and flash memory. Examples of the program instructions include a machine language code produced by a compiler, as well as a high-level language code which can be executed by a computer using an interpreter. The hardware device described above may be configured to operate with at least one software module to perform the operations of the present disclosure, and vice versa.

Although the present disclosure has been described with reference to the embodiments above, it will be understood by those skilled in the art that various modifications and changes can be made to the present disclosure without departing from the spirit and scope of the present disclosure as set forth in the appended claims.

What is claimed is:

1. An operation method of a server to provide an advertisement, the operation method comprising:
receiving an HTTP request from a client; and
transmitting, to the client, an HTTP response with a script added, the script including at least one instruction to be executed on the client,
wherein the at least one instruction is executed by the client to prevent loading of at least one resource of the HTTP response based on whether the at least one instruction included in the script is executed on the client.

2. The operation method according to claim 1, wherein the at least one instruction is executed to load cascading style sheets (CSS).

3. The operation method according to claim 1, wherein the script is an inline script.

4. The operation method according to claim 1, wherein the at least one instruction of the script is obfuscated.

5. The operation method according to claim 1, wherein the at least one instruction of the script is executed to:
determine whether the at least one instruction included in the script is executed; and
remove at least one resource included in the HTTP response in the case that the at least one instruction included in the script is not executed.

6. The operation method according to claim 5, wherein, in determining whether the at least one instruction included in the script is executed,
the at least one instruction of the script is executed to:
determine whether loading of the at least one instruction is blocked; and
determine whether the at least instruction is modified.

7. The operation method according to claim 1, wherein the at least one instruction of the script is executed to, in the case that at least one resource included in the HTTP response is not removed, redirect to a preset separate page.

8. A non-transitory computer recording medium comprising at least one instruction executed by a processor,
wherein the at least one instruction is executed to:
receive an HTTP request from a client;
transmit, to the client, an HTTP response with a script added, the script including at least one instruction to be executed on the client, and
at least one instruction of the script is executed by the client to prevent loading of at least one resource of the HTTP response based on whether the at least one instruction included in the script is executed on the client.

9. The non-transitory computer recording medium according to claim 8, wherein at least one instruction of the script is executed to load cascading style sheets (CSS).

10. The non-transitory computer recording medium according to claim 8, wherein the script is an inline script.

11. The non-transitory computer recording medium according to claim 8, wherein the at least one instruction of the script is obfuscated.

12. The non-transitory computer recording medium according to claim 8, wherein the at least one instruction of the script is executed to:
determine whether the at least one instruction included in the script is executed; and
remove at least one resource included in the HTTP response in the case that the at least one instruction included in the script is not executed.

13. The non-transitory computer recording medium according to claim 12, wherein, in determining whether the at least one instruction included in the script is executed,
the at least one instruction of the script is executed to:
determine whether loading of the at least one instruction is blocked; and
determine whether the at least instruction is modified.

14. The non-transitory computer recording medium according to claim 8, wherein the at least one instruction of the script is executed to, in the case that at least one resource included in the HTTP response is not removed, redirect to a preset separate page.

15. An operation method of a client to output content comprising an advertisement, the operation method comprising:
transmit an HTTP request to a server;
receiving an HTTP response with a script added, the script including at least one instruction;
executing the at least one instruction of the script; and
outputting the HTTP response based on a result of the execution of the at least one instruction of the script,
wherein the at least one instruction is executed by the client to prevent loading of at least one resource of the HTTP response based on whether the at least one instruction included in the script is executed on the client.

16. The operation method according to claim 15, wherein the script is an inline script including at least one instruction which is executed to load cascading style sheets (CSS).

17. The operation method according to claim 15, wherein the at least one instruction of the script is obfuscated.

18. The operation method according to claim 15, wherein the executing of the at least one instruction of the script comprises:
determining whether the at least one instruction included in the script is executed; and
removing at least one resource included in the HTTP response in the case that the at least one instruction included in the script is not executed.

19. The operation method according to claim 18, wherein the determining of whether the at least one instruction included in the script is executed comprises:
determining whether loading of the at least one instruction is blocked; and
determining whether the at least one instruction is modified.

20. The operation method according to claim 15, further comprising:
in the case that at least one resource included in the HTTP response is not removed. redirecting to a preset separate page.
